(19) United States
(12) Patent Application Publication
(10) Pub. No.: US 2024/0156106 A1
(43) Pub. Date: May 16, 2024

(54) FORMING SOCKET

(71) Applicant: CUPFFEE LTD, Plovdiv (BG)

(72) Inventor: Miroslav Atanasov ZAPRYANOV, Plovidv (BG)

(21) Appl. No.: 18/284,021

(22) PCT Filed: Mar. 16, 2022
(86) PCT No.: PCT/BG2022/000004

§ 371 Date: Sep. 25, 2023

(30) Foreign Application Priority Data
Mar. 23, 2021 (BG) 113350

(51) Int. Cl. A21B 5/02; A21D 13/33

(52) U.S. Cl. CPC A21B 5/026; A21D 13/33

(57) ABSTRACT

The invention relates to a forming socket of a forming and baking machine for manufacturing of edible, biodegradable containers for hot and cold beverages and food. The forming socket (1) of the forming and baking machine, includes a body (2), in which a mold (3) is mounted, whereby a punch (4) is movably positioned in the mold (3). Between the punch (4) and the mold (3) are installed one or more forming elements, above and/or on the sides of which a production waste area (16) is formed. The forming element (15) is an integral or consisting of two arcs, conical or cylindrical ring.

### FIELD OF THE INVENTION

The invention relates to a forming socket of a forming and baking machine for manufacturing of edible, biodegradable containers for hot and cold beverages and food, which will be used in the food industry.

### BACKGROUND OF THE INVENTION

There is a known line for the production of edible, biodegradable hot and cold beverages and food containers (WO2019/119075). The line consists of a control unit connected to a sequentially installed kneading machine, dosing machine, forming and baking machine, cooling tunnel, labeling machine and packaging machine, all of which are connected by a conveyor belt.

The forming and baking machine comprises at least one forming unit, which includes one or more forming sockets. Each forming socket is composed of a body in which is placed a dismountable mold with a heater. A hollow punch is movably positioned in the mold, whereby a gap with a preselected width is formed between the mold and the hollow punch. A heater is installed in the punch cavity.

The punch ends with a flange located outside of the forming socket, with openings formed on the periphery of the flange. Around the punch, beneath the flange, an unloading element having the shape of a washer is movably positioned, with openings formed at its periphery, coinciding with the openings on the flange. Linear guides are mounted in the peripheral openings of the flange and the unloading element.

The known solution requires the use of a precision dosing machine that measures the exact amount of dough fed to each molding well, as well as placing the dough, which is usually spherical in shape, in the center of the bottom of each molding socket. Even a slight deviation from the weight and the placement center of the dough in the forming socket, leads to unwanted, significant waste of production. This is due to the fact that after pressing the dough in the forming socket with the hollow punch, on the periphery of the products (in this case cups) are formed wavy unfilled sections or sections of different densities. In this case, there is a significant area of technological waste. The technological waste formation area is outside the mold.

Ultimately, this leads to significant waste, loss of time to eliminate the waste and increases the cost of production.

### SUMMARY OF THE INVENTION

The task of the invention is to create a forming socket of a forming and baking machine, aimed to increase of labor productivity and reduce of the waste in the production of edible, biodegradable containers for hot and cold drinks and food.

This task is resolved by a forming socket for a forming and baking machine, composed of a body, in which a mold is mounted and a punch is movably positioned in the mold.

According to the invention, one or more forming elements are positioned between the punch and the mold, above and/or the side of which is formed a production waste area.

A heater is installed in an opening, formed in the punch. Another heater can also be installed in a cavity formed in the body, in which the mold is installed.

According to one embodiment of the invention, the forming element is an integral or consisting of two arcs conical or cylindrical ring.

In this embodiment, the lower edge of the forming element may be chamfered or shaped at a certain angle to the body of the forming element.

In another embodiment of the invention, the forming element is an integral or consisting of two arcs conical or cylindrical tooth. In this case, too, the molding element can be chamfered. The forming elements can be attached to the outer surface of the punch and/or to the inner surface of the mold.

In a still further embodiment of the invention, the forming elements are formed on the inner surface of the mold and/or on the outer surface of the punch, as an integral part of them.

In order to facilitate the removing of the product, the mold of the forming socket can be divided to at least two symmetrical parts.

The mold and the punch are in the shape of inverted truncated cones.

At least two forming sockets can be combined to form one forming unit, where the punches of the forming sockets are mounted to a common plate.

In the indicated designs of forming units, the area of technological waste is formed above the forming elements, but inside the forming sockets, whereby the technological waste is formed under controlled pressure.

These designs allow the manufacturing of products with uniform density and homogeneity of their walls and bottoms, which increases their quality. This leads to increased durability, especially when used for hot drinks.

The proposed designs of forming sockets do not require a precise dividing machine to determine the exact amount of dough (dose), nor does it require accurate positioning of the dough dose in the socket.

In general, the advantages of the invention are mainly the reducing of the technological waste, the production time and the production unit cost.

### BRIEF DESCRIPTION OF THE DRAWINGS

The accompanying figures show an exemplary embodiment of the invention, where:

FIG. 1 is an axonometric view of a forming socket.

FIG. 2 is an axonometric view of an unloading element, which removes the finished container.

FIG. 3 is an axonometric view of a punch.

FIG. 4 is a cross sectional axonometric view of a forming socket with a forming element in the shape of a conical ring;

FIG. 5 is a view of the technological waste area;

FIG. 6 is a cross sectional axonometric view of a forming socket with a forming element, being a monolithic part of the mold;

FIG. 7 is a cross sectional axonometric view of a forming socket with a forming element, being a monolithic part of the unloading element;

FIG. 8 is a cross sectional axonometric view of a forming socket with a forming element in the shape of a ring, affixed to the mold

FIG. 9 is a cross sectional axonometric view of a forming socket with a forming element in the shape of a ring, being a monolithic part of the punch;

FIG. 10 is a cross sectional axonometric view of a forming socket with a forming element in the shape of a ring, affixed to the punch;

FIG. 11 is a cross sectional axonometric view of another forming socket embodiment with a forming element, being a monolithic part of the punch;

FIG. 12 is an axonometric view of an embodiment of the invention, having a divided forming socket with a limiting element;

FIG. 13 is an axonometric view of a composite forming unit; and

FIG. 14 is an embodiment of a composite forming unit.

### DETAILED DESCRIPTION OF THE INVENTION

Exemplary embodiments of forming sockets for the production of edible, biodegradable containers for hot and cold beverages and food are presented in the accompanying figures.

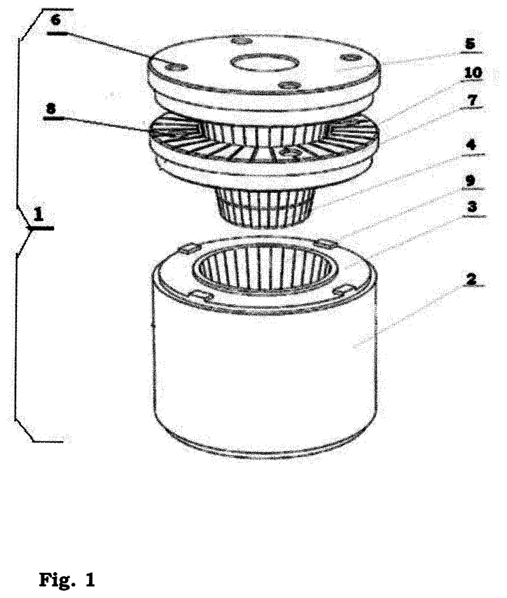

The forming sockets 1 can be of any shape—a coffee cup, tea cup, soup bowl, etc., but in the present embodiment it is a coffee cup. (FIG. 1)

Each forming socket 1 is made of a body 2, in which a mold 3 is detachably mounted, whereby an upper forming part, in this case a hollow punch 4, is movably positioned in the mold.

The punch 4 may end with a flange 5, on the periphery of which are made cylindrical openings 6. Around the punch 4 and beneath the flange 5, an unloading element 7 is movably positioned, whereby said unloading element 7 is with a shape of a washer and also has cylindrical openings 8, formed at its periphery. The unloading element 7 is used to remove the already roasted coffee cup from the punch 4.

In this case, the mold 3 is provided with fine grooves 9, most often vertical along the inner surrounding surface of the mold 3.

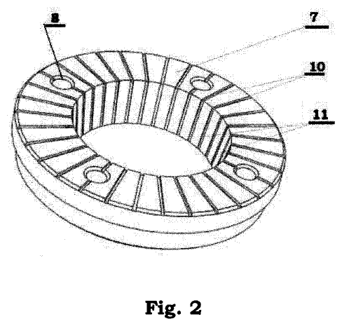

Vertical grooves 11 can be made on the inner surface of the unloading element 7 for removal of the air and water vapors, coming from the cups forming process. (FIG. 2)

In this embodiment, radial grooves 10 are made on the upper surface of the unloading element 7, connected to the vertical grooves 11.

Linear guides (not shown in the figures) are mounted in the cylindrical opennings 6 of the flange 5 and in the cylindrical opennings 8 of the unloading element 7, ensuring the linear movement of the unloading element 7, relatively to the punch 4.

As noted above, the mold 3 is mounted in the body 1, which in this case is in the form of an inverted truncated cone. The mold 3 forms the outer surface of the edible cup.

The grooves 9 are used to remove the air and water vapors, coming from the process of forming and baking the product.

In the body 2, near and around the mold 3, are installed heaters for baking the edible dish. These heaters are not shown in the accompanying figures.

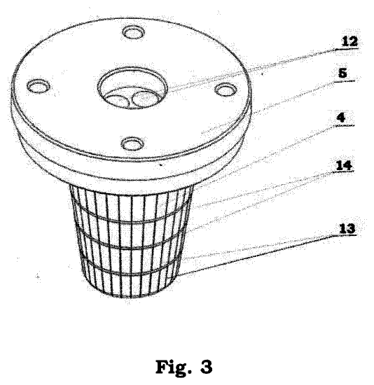

At least one heater 12 for roasting the edible container—a coffee cup, is installed in the central part of the punch 4 along its inner cavity (FIG. 3).

The punch 4 is also in the shape of an inverted truncated cone and laterally, on its outer surface, can be formed longitudinal channels 13 to allow the removal of the air and water vapors, coming from the process of forming and baking the cups. On the outer surface ofthe punch 4, concentric cylindrical retaining grooves 14, perpendicular to the longitudinal grooves 13, can also be made. The retaining grooves 14 ensure the retention of the finished product (the finished coffee cup) to the punch 4. This is a solution is necessary in particular for the cases where the mold 3 is not divided.

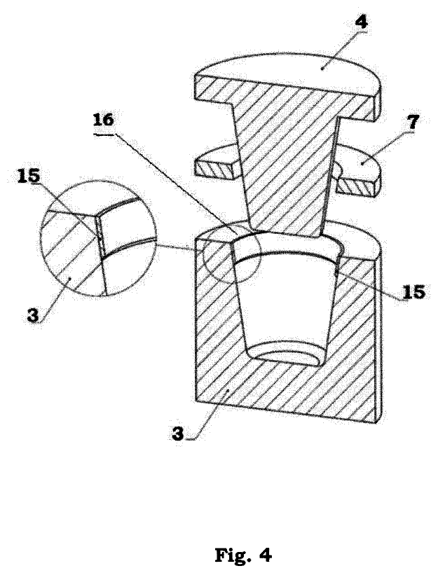

FIG. 4 shows a forming socket 1 with a free-standing in its upper part forming element 15, in particular in the area of the technological waste 16. In this case, the forming element 15 is an integral or consisting of two arcs conical ring, mounted between the punch 4 and the mold 3.

The forming element 15 significantly reduces the distance (the gap) between the punch 4 and the mold 3 in the area of the technological waste 16.

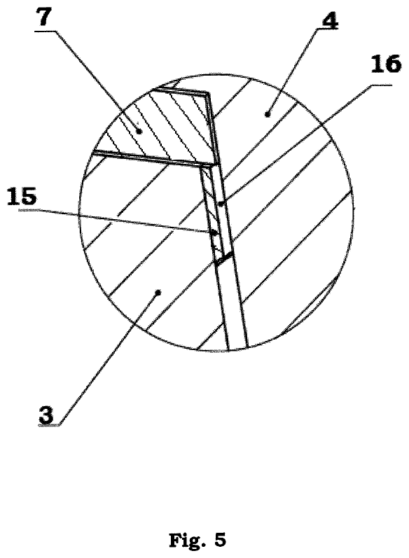

When pressing the dough between the mold 3 and the punch 4, the dough gradually and evenly fills the gap in between, thanks to the forming element 15 (FIG. 5). The reducing the gap between the mold 3 and the punch 4 has a favorable effect on the density of the finished product.

Thus is obtained a cup with a dense, homogeneous walls, while the technological waste is reduced. Another advantage is that less precise weighing and dosing devices can be used. It is also not necessary to observe the placement of the dough exactly in the center of the bottom of the mold 3.

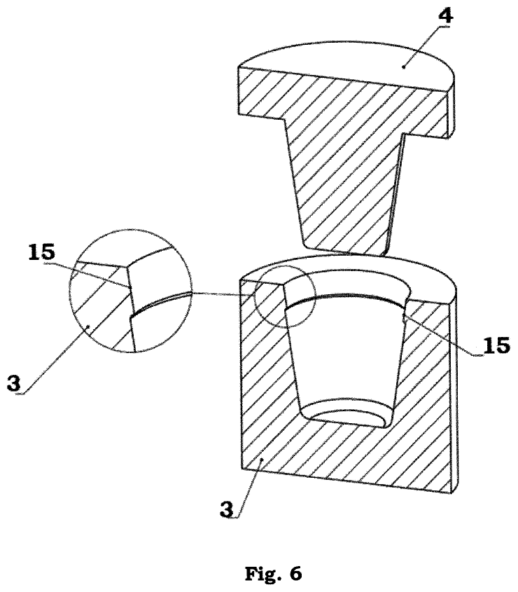

An embodiment of a forming socket, according to the present invention, is shown in FIG. 6. In this case, the forming element 15 is a monolithic part of the mold 3.

In the two embodiments, shown in FIG. 4 and FIG. 5, the lower edge of the forming element 15 is chamfered or shaped at a certain angle to the body of the forming element 15 itself.

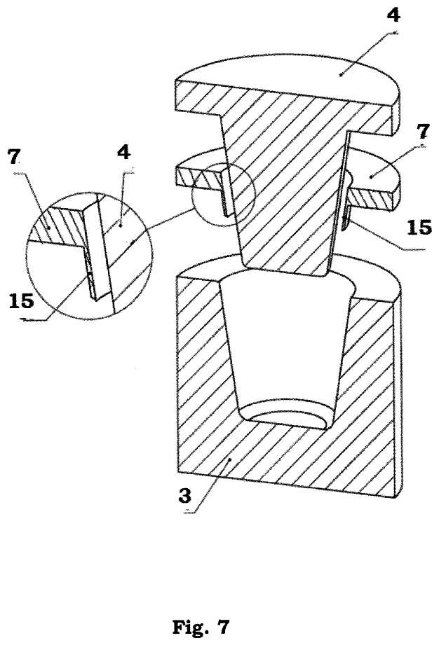

The forming element 15 may also be a part of the unloading element 7, as shown in FIG. 7.

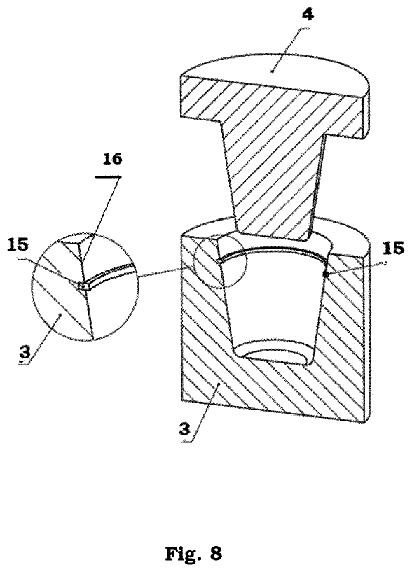

The following FIG. 8 shows a forming socket with a ring-shaped forming element 15, which is attached to the mold 3 or is an integral part of it—it is made in the mold 3. In this case, the technological waste area 16 is formed above the forming element 15, between the punch 4 and the mold 3.

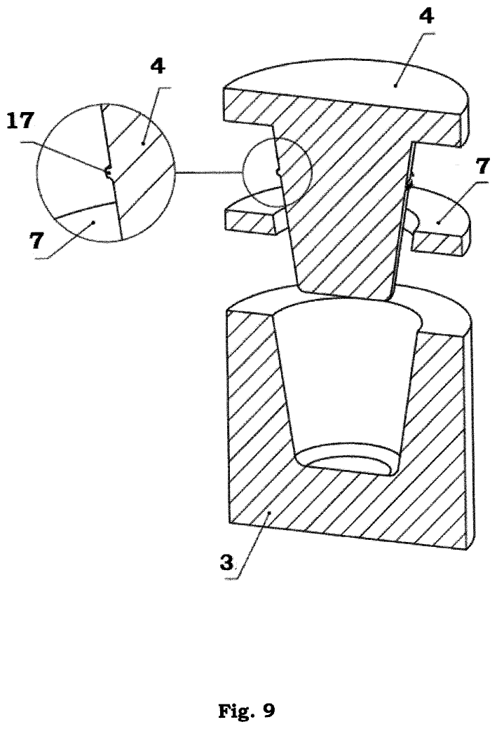

Accordingly, FIG. 9 shows a forming socket with a forming element in the shape of a conical tooth 17, being a monolithic part of the punch 4.

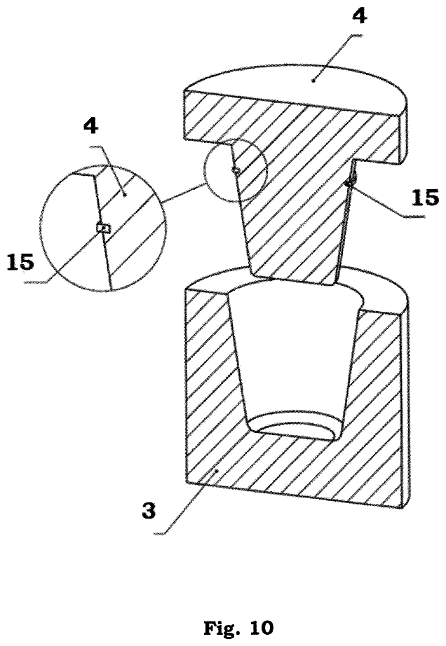

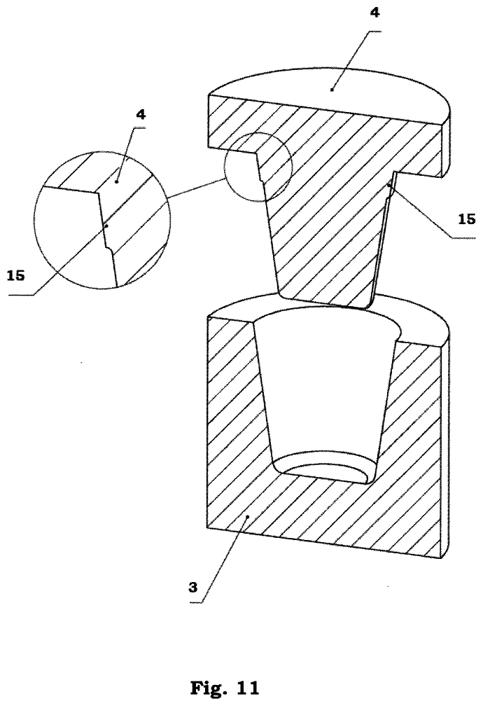

The ring-shaped forming element 15 can be affixed to the punch 4, as shown in FIG. 10, but it also may be an integral part of the punch 4—FIG. 11.

The forming element 15 may also have another shape—for example, a forming tooth (edge) 17 and the like. The forming tooth 17 can also be chamfered.

The molding elements 15 can be mounted in different positions along the height of the punch 4 and the mold 3, depending on the desired size of the product—the size of the cup.

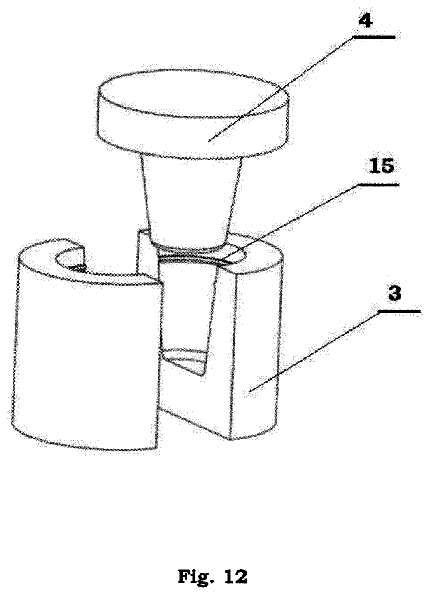

In order to ensure the smooth removal of the finished cup from the forming socket 1, the latter can be made of two or more symmetrical parts, which open after the baking of the cup. (FIG. 12) As can be seen from the accompanying figures, in some embodiments of the invention there is no need for the unloading element 7, which simplifies the design and reduces the costs.

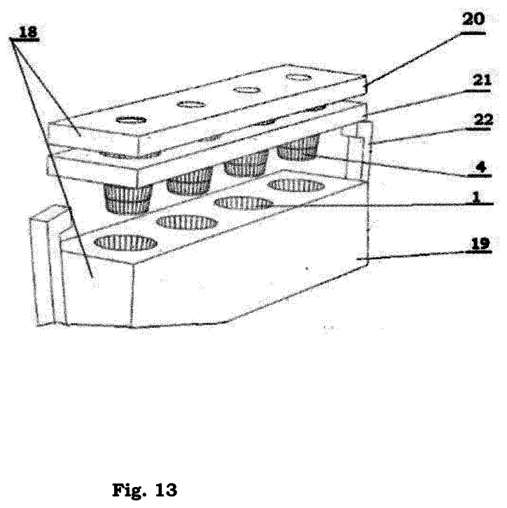

The forming sockets 1 can be combined in a forming unit 18, whereby the forming sockets 1 may be of different type and shape and different number, forming separate containers with the same or different shapes—FIG. 13.

The sockets 1 can be separated from each other and at the same time grouped in a common carrier plate 19, so as to form a common forming unit 18. When several forming sockets 1 are grouped in a common forming unit 18, their upper cylindrical parts—the flanges 5 of the punches 4—are also incorporated in a common upper plate 20, and unloading elements 7 are incorporated in a common movable unloading plate 21.

In this case, the system can be provided with a locking mechanism 22, which is for example a bracket (but can also be in another form), ensuring the immobility of the upper plate 20, relatively to the carrier plate 19 during the baking process.

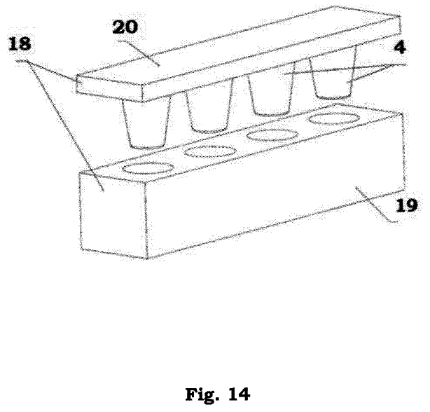

The following FIG. 14 shows an embodiment of a forming unit, where no unloading elements 7 are used and, accordingly, the common movable unloading plate 21 is missing.

All elements of the forming units and their corresponding forming sockets are made of metal, suitable for contact with food—for example, aluminum, stainless steel, cast iron or other materials, having the required qualities.

### Mode of Operation

After kneading and resting, the dough is feeding to the collecting hopper of a dosing machine. The dough divides into doses, each with a weight, corresponding to the type of product to be prepared—coffee cups in this case.

The already dosed dough is placed in the molds 3 of the forming and baking machine, having a mechanical, hydraulic or pneumatic drive press (not shown in the figures). The forming unit 18 itself may have different in number, type and shape sockets 1, forming the individual cups.

Thereafter, each dose of dough is formed by pressing each preheated punch 4 to its corresponding heated mold 3.

The baking of the dough, after forming between the two parts of the sockets 1, is carried out at a temperature between 150° C. and 200° C. for a certain period of time. For this purpose, the heaters of the molds 3 and the heaters 12 of the punches 4 are constantly heated, while the thermal controllers monitor the maintenance of the desired exact temperature. Baking time is directly dependent on the baking temperature, the size and thickness of the cup and the desired degree of baking. Usually the baking time is about 2-3.5 minutes.

During the baking process, the dough swells unevenly in the baking form and if there is no securing element, after reaching the top edge, the excess dough comes out through opennings, left in the form. In the proposed design, however, there are very small and fine openings, allowing the exit of the air from the mold 3 in order to reduce slowly the pressure, created during baking process. The opennings are so small, that only the air and the water vapors can pass, but not the dough. The process is baking under a controlled pressure release, which in turn determines the removal of large amounts of air from the product and increases its density in times. In the proposed design of the forming socket 1, there are no means to allow the overdose of dough to come out and therefore there is an inner waste zone, which is also formed under pressure. The forming element 15 is necessary, because when the rising dough reaches it, the dough cannot go higher and begins to rotate to the left and right from the point of initial contact with the forming element 15. Only after filling the entire space in the mold under the forming element 15, the excess dough passes over it, forming a technological waste, which is again baked under pressure without leaving the mold, thus ensuring the high density of the finished product.

As noted above, the heating of the forming sockets 1 and the punches 4 is done by means of reothanes, but can also be done in another way, for example, by gas or by a preheated fluid circulating through the molds 3.

The unloading element 7, respectively the common unloading plate 20, is designed to push the finished cup (cups) out of the punch(es) 4. The unloading element 7 can be in the form of individual ring, be a separate element or built into the punch.

The unloading of the baked cups from the divided molds 3 is also facilitated by the separation of their two constituent parts and facilitate the falling out of the baked cups.

After the unloading, the product is cooled to room temperature in a cooling tunnel and taken for labeling and packaging by the labeling and packaging machines.

To the product thus obtained, an additional element can be attached—a label, representing an arcuate adhesive tape with an unfolding handle, which is an exemplary embodiment of the product.

The product (coffee cup) can be made with a handle of the same dough for a convenient use.

The product thus prepared is a low hygroscopic, edible, waffle (biscuit) cup or bowl. It is designed for serving of hot and cold liquids such as soups, coffee, cappuccino, hot chocolate, hot and cold milk and other foods and beverages. The product can be consumed after use.

If it is not consumed, but disposed of, the product thus created is environmentally safe and is 100% biodegradable in a short time.

1. Forming socket (1) of a forming and baking machine, consisting of a body (2), in which a mold (3) is mounted, whereby a punch (4) is movably positioned in the mold (3),
characterized in that,
between the punch (4) and the mold (3) are installed one or more forming elements (15), above and/or on the sides of which a production waste area (16) is formed.

2. Forming socket (1), according to claim 1, characterized in that a heater (12) is installed in an opening, formed in the punch (4).

3. Forming socket (1), according to claim 1, characterized in that a heater is installed in a cavity, formed in the body (2), in which the mold (3) is mounted.

4. Forming socket (1), according to claim 1, characterized in that the forming element (15) is an integral or consisting of two arcs, conical or cylindrical ring.

5. Forming socket (1), according to claim 4, characterized in that the lower edge of the forming element (15) is chamfered or shaped at a certain angle to the body of the forming element (15).

6. Forming socket (1), according to claim 1, characterized in that the forming element (15) is an integral or consisting of two arcs conical or cylindrical tooth.

7. Forming socket (1), according to claim 1, characterized in that the forming elements (15) are attached to the outer surface of the punch (4) and/or to the inner surface of the mold (3).

8. Forming socket (1), according to claim 1, characterized in that the forming elements (15) are formed on the inner surface of the mold (3) and/or on the outer surface of the punch (4), as an integral part of them.

9. Forming socket (1), according to claim 1, characterized in that the mold (3) is divided and consists of at least two symmetrical parts.

10. (canceled)

11. (canceled)

12. (canceled)

13. Forming socket (1), according to claim 1, characterized in that the mold (3) is in the shape of inverted truncated cone.

14. Forming socket (1), according to claim 2, characterized in that the mold (3) is in the shape of inverted truncated cone.

15. Forming socket (1), according to claim 3, characterized in that the mold (3) is in the shape of inverted truncated cone.

16. Forming socket (1), according to claim 4, characterized in that the mold (3) is in the shape of inverted truncated cone.

17. Forming socket (1), according to claim 5, characterized in that the mold (3) is in the shape of inverted truncated cone.

18. Forming socket (1), according to claim 6, characterized in that the mold (3) is in the shape of inverted truncated cone.

19. Forming socket (1), according to claim 7, characterized in that the mold (3) is in the shape of inverted truncated cone.

20. Forming socket (1), according to claim 8, characterized in that the mold (3) is in the shape of inverted truncated cone.

21. Forming socket (1), according to claim 9, characterized in that the mold (3) is in the shape of inverted truncated cone.

22. Forming socket (1), according to claim 1, characterized in that the punch (4) is in the shape of inverted truncated cone.

23. Forming socket (1), according to claim 2, characterized in that the punch (4) is in the shape of inverted truncated cone.

24. Forming socket (1), according to claim 3, characterized in that the punch (4) is in the shape of inverted truncated cone.

25. Forming socket (1), according to claim 4, characterized in that the punch (4) is in the shape of inverted truncated cone.

26. Forming socket (1), according to claim 5, characterized in that the punch (4) is in the shape of inverted truncated cone.

27. Forming socket (1), according to claim 6, characterized in that the punch (4) is in the shape of inverted truncated cone.

28. Forming socket (1), according to claim 7, characterized in that the punch (4) is in the shape of inverted truncated cone.

29. Forming socket (1), according to claim 8, characterized in that the punch (4) is in the shape of inverted truncated cone.

30. Forming socket (1), according to claim 9, characterized in that the punch (4) is in the shape of inverted truncated cone.

31. Forming socket (1), according to claim 1, characterized in that at least two forming sockets (1) are combined in one forming unit (18), whereby the punches (4) of the forming sockets (1) are mounted to a common plate (20).

32. Forming socket (1), according to claim 2, characterized in that at least two forming sockets (1) are combined in one forming unit (18), whereby the punches (4) of the forming sockets (1) are mounted to a common plate (20).

33. Forming socket (1), according to claim 3, characterized in that at least two forming sockets (1) are combined in one forming unit (18), whereby the punches (4) of the forming sockets (1) are mounted to a common plate (20).

34. Forming socket (1), according to claim 4, characterized in that at least two forming sockets (1) are combined in one forming unit (18), whereby the punches (4) of the forming sockets (1) are mounted to a common plate (20).

35. Forming socket (1), according to claim 5, characterized in that at least two forming sockets (1) are combined in one forming unit (18), whereby the punches (4) of the forming sockets (1) are mounted to a common plate (20).

36. Forming socket (1), according to claim 6, characterized in that at least two forming sockets (1) are combined in one forming unit (18), whereby the punches (4) of the forming sockets (1) are mounted to a common plate (20).

37. Forming socket (1), according to claim 7, characterized in that at least two forming sockets (1) are combined in one forming unit (18), whereby the punches (4) of the forming sockets (1) are mounted to a common plate (20).

38. Forming socket (1), according to claim 8, characterized in that at least two forming sockets (1) are combined in one forming unit (18), whereby the punches (4) of the forming sockets (1) are mounted to a common plate (20).

39. Forming socket (1), according to claim 9, characterized in that at least two forming sockets (1) are combined in one forming unit (18), whereby the punches (4) of the forming sockets (1) are mounted to a common plate (20).
